(19) United States
(12) Patent Application Publication
(10) Pub. No.: US 2026/0121703 A1
(43) Pub. Date: Apr. 30, 2026

(54) METHOD AND APPARATUS OF BASE STATION SUPPORTING MULTIPLE BEAMFORMING IN WIRELESS COMMUNICATION SYSTEM

(71) Applicant: SAMSUNG ELECTRONICS CO., LTD., Suwon-si (KR)

(72) Inventors: Jaehong PARK, Suwon-si (KR); Kihyun KIM, Suwon-si (KR); Younghwan KIM, Suwon-si (KR); Jinhyun KIM, Suwon-si (KR); Sunggi YANG, Suwon-si (KR); Sangho LEE, Suwon-si (KR)

(73) Assignee: SAMSUNG ELECTRONICS CO., LTD., Suwon-si (KR)

(21) Appl. No.: 19/368,607

(22) Filed: Oct. 24, 2025

Related U.S. Application Data
(63) Continuation of application No. PCT/KR2025/016827, filed on Oct. 22, 2025.

(30) Foreign Application Priority Data
Oct. 24, 2024 (KR) 10-2024-0146955

(51) Int. Cl. H04B 7/0456

(52) U.S. Cl. CPC H04B 7/0456

(57) ABSTRACT

The disclosure includes a base station including a plurality of antenna elements configured to perform beam adjustment in horizontal and vertical directions to form two or more reception beams for multi-beamforming for a plurality of user equipments (UEs), and a plurality of radio frequency (RF) chains configured to amplify RF signals received via the plurality of antenna elements, perform phase adjustment for the multi-beamforming associated with the amplified RF signals, and output the phase-adjusted signals, wherein each RF chain of the plurality of RF chains includes a low-noise amplifier of which an input end is connected to one antenna element of the plurality of antenna elements and at least one output end is connected to two or more phase shifters, and which is configured to amplify an RF signal provided via the input end, and the two or more phase shifters configured to perform phase adjustment for the multi-beamforming associated with the amplified RF signal received via the two or more reception beams in each RF chain for respective two or more UEs.

### CROSS-REFERENCE TO RELATED APPLICATION(S)

This application is a continuation application, claiming priority under 35 U.S.C. § 365(c), of an International application No. PCT/KR2025/016827, filed on Oct. 22, 2025, which is based on and claims the benefit of a Korean patent application number 10-2024-0146955, filed on Oct. 24, 2024, in the Korean Intellectual Property Office, and the disclosure of each of which is incorporated by reference herein in its entirety.

### BACKGROUND

The disclosure relates to a method and apparatus for a base station that supports beamforming in a wireless communication system.

A 5G system has been developed and commercialized in order to satisfy the demand for wireless data traffic that has increased beyond a 4G system (i.e., long-term evolution (LTE) system). The 5G system may be implemented in an ultra-high frequency wave (mmWave) band. In order to mitigate a path loss of radio waves and to increase a propagation distance of radio waves in the ultra-high frequency band, beamforming, massive multiple-input and multiple-output (MIMO), full dimensional MIMO (FD-MIMO), array antenna, analog beam-forming, and large scale antenna technologies are being studied in association with the 5G system.

In a base station in a MIMO-based 5G system that uses the ultra-high frequency (mmWave) band, single or multiple beams may be formed using an array antenna and may be used for communication. The base station may focus a signal in each direction of one or multiple user equipments (UEs) via beamforming that forms a single beam or multiple beams, and may improve the quality of communication.

The necessity of using multiple beams in the base station of the 5G system is increasing. In the mmWave band, a bandwidth that a single communication operator secures may be up to, for example, 400 MHz-1.6 GHz. In many cases, a bandwidth that the base station uses when performing communication with a single user equipment (UE) may be smaller than the secured bandwidth due to the limited hardware performance/specifications of the UE. In addition, due to issues such as a UE's output end performance/power consumption or the like, a smaller bandwidth is frequently used in uplink (UL) transmission to the base station as compared with a case of downlink (DL) transmission to the UE from the base station.

FIG. 1 is a diagram illustrating an example of a base station that communicates with UEs by using multiple beams in a wireless communication system.

Referring to FIG. 1, a base station 110 may be capable of allocating different sub-frequency bands to a plurality of UEs 121 and 122, and the base station 110 may simultaneously communicate with the plurality of UEs 121 and 122 without signal interference (or with reduced interference) by using beams 11 and 12 formed via multi-beamforming (multiple beamforming). As illustrated in FIG. 1, when the number of UEs that a base station, which uses multi-beamforming, is capable of simultaneously scheduling increases, uplink transmission occasions of each UE increase and a latency reduction effect may be provided.

FIGS. 2A and 2B illustrate examples of methods of communicating with UEs by using a single beam and multiple beams, by a base station, in a wireless communication system.

FIG. 2A illustrates an example in which a base station allocates different sub-frequency bands to UE1 and UE2, and performs communication using a single beam according to time division (e.g., time division multiplexing (TDM)). FIG. 2B illustrates an example in which a base station allocates different sub-frequency bands to UE1 and UE2, and simultaneously performs communication using multiple beams according to frequency division (e.g., frequency division multiplexing (FDM)).

As illustrated in FIGS. 2A and 2B, when a base station uses multi-beamforming, a cell throughput may significantly increase as compared with a case (e.g., time division-based communication with each UE) of using single beamforming.

In communication environments that dynamically vary, it is more advantageous to use multi-beamforming in the mmWave band that uses a broadband. In this instance, to implement multi-beamforming in a wireless communication system, a transmission/reception chain of a base station requires a complex structure and a large area, and thus the size of a radio-frequency integrated circuit (RFIC), also referred to as an RF chip, increases and the cost increases. Therefore, an efficient structure of a base station or RF chip used in the base station that decreases hardware complexity and reduces a required area in the base station or RF chip used in the base station that uses multi-beamforming may be required.

The disclosure provides a method and apparatus of a base station that may reduce the number of hardware elements and/or power consumption required while supporting multi-beamforming in a wireless communication system.

The disclosure provides an RF chip in a base station that may reduce the number of hardware elements and/or power consumption required while supporting multi-beamforming in a wireless communication system.

The disclosure provides a method and apparatus of a base station that may reduce the number of hardware elements and/or power consumption required while adaptively performing multi-beamforming and single beamforming in a wireless communication system.

A base station supporting multi-beamforming in a wireless communication system according to one or more embodiments may include an array antenna including a plurality of antenna elements capable of performing beam adjustment in horizontal and vertical directions in order to form two or more reception beams for the multi-beamforming for a plurality of UEs. In addition, the base station may include a plurality of radio frequency chains configured to amplify RF signals received via the plurality of antenna elements, perform phase adjustment for the multi-beamforming associated with the amplified RF signals, and output the phase-adjusted signals. In addition, in the base station, each RF chain of the plurality of RF chains may include a low-noise amplifier of which an input end is connected to one antenna element of the plurality of antenna elements and at least one output end is connected to two or more phase shifters, and which is configured to amplify an RF signal provided via the input end. In addition, in the base station, each RF chain of the plurality of RF chains may include two or more phase shifters configured to perform phase adjustment for the multi-beamforming associated with the amplified RF signal received via the two or more reception beams in each RF chain for respective two or more UEs.

In addition, based on the two or more reception beams comprising first to n^{th} reception beams, the two or more phase shifters included in each RF chain may include first to n^{th} phase shifters. In addition, the first to n^{th} phase shifters in each RF chain may be configured to perform the phase adjustment for the multi-beamforming associated with the first to n^{th} reception beams for respective first to n^{th} UEs.

In addition, the two or more phase shifters may use one from among a single ended (SE) phase shifter, a differential phase shifter, and a pseudo differential phase shifter, and the pseudo differential phase shifter may be configured such that two or more SE phase shifters are connected to alternating current (AC) ground.

In addition, based on the pseudo differential phase shifter being used as the two or more phase shifters, the low-noise amplifier is configured to output a differential signal and the pseudo differential phase shifter is configured to receive the differential signal and output a phase-adjusted signal.

In addition, an RF chip comprising the plurality of RF chains may further include at least one combiner configured to receive and combine, in the plurality of RF chains, signals that are phase-adjusted by the two or more phase shifters, and perform output.

In addition, the base station may further include a processor configured to control operation of the base station for the multi-beamforming, and the processor may control set values in a register of the two or more phase shifters for the multi-beamforming.

In addition, the processor may be configured to perform communication with the plurality of UEs by dynamically applying one of the multi-beamforming and single-beamforming based on channel state information of the plurality of UEs, different register set values are applied to the two or more phase shifters in case that the multi-beamforming is applied, and an identical register set value is applied to the two or more phase shifters in case that the single-beamforming is applied.

An RF chip for a bases station according to one or more embodiments comprises a plurality of RF chains configured to amplify RF signals received via a plurality of antenna elements, perform phase adjustment for multi-beamforming associated with the amplified RF signals, and output the phase-adjusted signals.

In addition, each RF chain of the plurality of RF chains in the RF chip may include a low-noise amplifier of which an input end is connected to one antenna element of the plurality of antenna elements and at least one output end is connected to two or more phase shifters, and which is configured to amplify an RF signal provided via the input end and output an amplified output signal.

In addition, each RF chain of the plurality of RF chains in the RF chip may include two or more phase shifters configured to perform phase adjustment for the multi-beamforming associated with the amplified RF signal received via the two or more reception beams in each RF chain for respective two or more UEs.

A base station according to one or more embodiments may include an array antenna including a plurality of antenna elements configured to perform beam adjustment in horizontal and vertical directions to form two or more transmission beams for multi-beamforming associated with a plurality of UEs. In addition, the base station may include a plurality of RF chains configured to perform phase adjustment for the multi-beamforming associated with RF signals transmitted via the plurality of antenna elements, and amplify and output the phase-adjusted RF signals. In addition, in the base station, each RF chain of the plurality of RF chains may include a power amplifier of which an output end is connected to one antenna element of the plurality of antenna elements and at least one input end is connected to two or more phase shifters, and which is configured to amplify an RF signal provided via the at least one input end. In addition, the base station may include two or more phase shifters configured to perform phase adjustment for the multi-beamforming associated with RF signals transmitted via the two or more transmission beams in each RF chain for respective two or more UEs.

An RF chip for a base station according to one or more embodiments, may include a plurality of RF chains configured to perform phase adjustment for multi-beamforming associated with RF signals transmitted via a plurality of antenna elements, and amplify and output the phase-adjusted RF signals. In addition, in the RF chip, each RF chain of the plurality of RF chains may include a power amplifier of which an output end is connected to one antenna element of the plurality of antenna elements and at least one input end is connected to two or more phase shifters, and which is configured to amplify an RF signal provided via the at least one input end. In addition, the RF chip may include two or more phase shifters configured to perform phase adjustment for the multi-beamforming associated with RF signals transmitted via the two or more transmission beams in each RF chain for respective two or more UEs.

### BRIEF DESCRIPTION OF DRAWINGS

FIG. 1 is a diagram illustrating an example of a base station that communicates with UEs by using multiple beams in a wireless communication system;

FIGS. 2A and 2B are diagrams illustrating an example of a method of communicating with UEs by using a single beam or multiple beams, by a base station, in a wireless communication system;

FIG. 3 is a diagram illustrating a configuration example of a reception device of a base station that uses multi-beamforming in a wireless communication system;

FIG. 4 is a diagram illustrating a configuration example of a reception device of a base station that uses multi-beamforming in a wireless communication system according to one or more embodiments;

FIGS. 5A and 5B are diagrams illustrating examples of simulation results of a single beam and dual beams in the reception device structure of the base station of FIG. 4 according to one or more embodiments;

FIG. 6 is a diagram illustrating a simulation result of an SNR degradation degree of a UE1 signal based on a relative position of UE2 when the reception device structure of the base station of FIG. 4 forms dual beams for UE1 and UE2, according to one or more embodiments;

FIG. 7A is a diagram illustrating an example of a differential phase shifter applicable to a base station that uses multi-beamforming according to one or more embodiments;

FIG. 7B is a diagram illustrating an example of a pseudo differential phase shifter applicable to a base station that uses multi-beamforming according to one or more embodiments;

FIG. 8 is a diagram illustrating a configuration example of a reception device of a base station that uses the pseudo differential phase shifter of FIG. 7B for multi-beamforming in a wireless communication system according to one or more embodiments;

FIG. 9 is a diagram illustrating a configuration example of a reception device of a base station that uses the pseudo differential phase shifter of FIG. 7B for multi-beamforming in a wireless communication system according to one or more embodiments;

FIG. 10 is a diagram illustrating an example of a method performed in a reception device of a base station that uses multi-beamforming in a wireless communication system according to one or more embodiments;

FIGS. 11A and 11B are diagrams illustrating examples of simulation results of dual beams and quadruple beams in a reception device structure of a base station according to one or more embodiments;

FIG. 12 is a diagram illustrating an example of a method of approximating a resultant vector of multiple beams as a sum of two vectors, for multi-beamforming in a wireless communication system according to one or more embodiments;

FIG. 13 is a diagram illustrating a configuration example of a reception device of a base station for multi-beamforming in a wireless communication system to which the method of FIG. 12 is applied, according to one or more embodiments;

FIG. 14 is a diagram illustrating a configuration example of a transmission device of a base station that uses multi-beamforming in a wireless communication system according to one or more embodiments;

FIG. 15 is a diagram illustrating a configuration example of a transmission device of a base station that uses the pseudo differential phase shifter of FIG. 7B for multi-beamforming in a wireless communication system according to one or more embodiments; and

FIG. 16 is a diagram illustrating a configuration example in which a transmission device and a reception device of a base station are combined for multi-beamforming in a wireless communication system according to one or more embodiments.

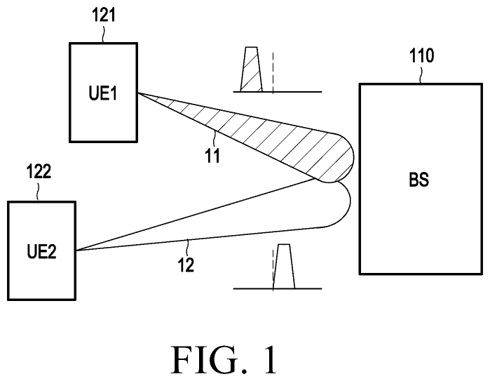

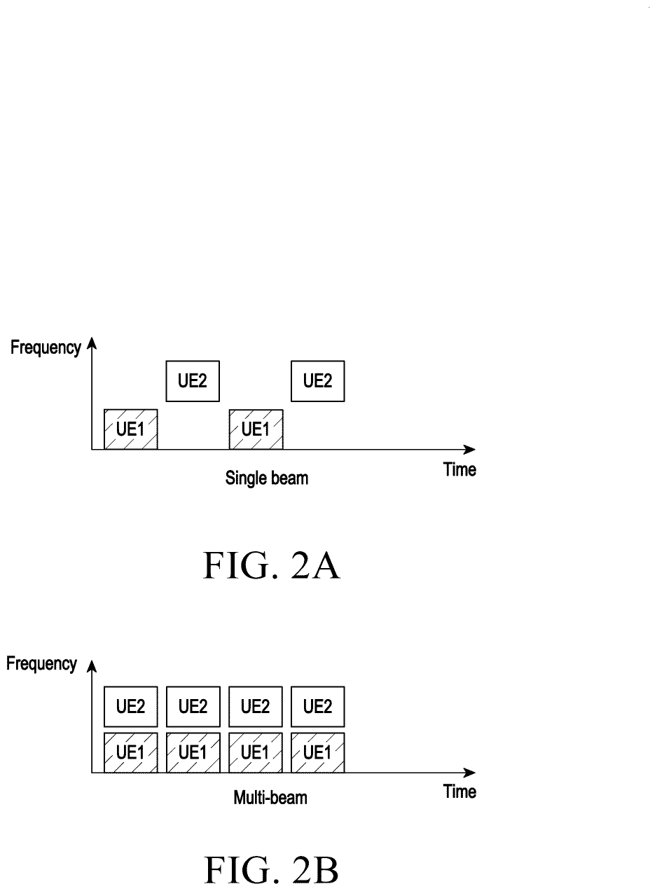

### DETAILED DESCRIPTION

Hereinafter, the operation principle will be described in detail in conjunction with the accompanying drawings. In addition, a detailed description of known functions or configurations that may make the subject matter unclear will be omitted. The terms which will be described below are terms defined in consideration of the functions in the disclosure, and may be different according to users, intentions of the users, or customs. Therefore, the definitions of the terms should be made based on the contents throughout the specification.

The advantages and features and ways to achieve them will be apparent by making reference to embodiments as described herebelow in detail in conjunction with the accompanying drawings. However, as the embodiments described herein are example embodiments, and thus, the disclosure is not limited to these embodiments, but may be implemented in various different forms. The following embodiments are provided only to completely disclose the disclosure and inform those skilled in the art of the scope, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

As used herein, each of such phrases as “A and/or B,” “at least one of A and B,” “at least one of A or B,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

As used herein, a base station (BS) refers to a network entity capable of allocating resources to terminals and communicating with the terminals through a wireless network, and may be at least one of an eNode B, a Node B, a gNB, a radio access network (RAN), an access network (AN), an RAN node, an integrated access/backhaul (IAB) node, a wireless access unit, a base station controller, a node on a network, or a transmission reception point (TRP). A user equipment (UE) may be at least one of a terminal, a mobile station (MS), a cellular phone, a smartphone, a computer, or a multimedia system capable of performing a communication function.

In the disclosure, multi-beamforming may be applied to MIMO technology capable of supporting an improved transmission capacity to a plurality of UEs, and a base station may form multiple beams via multi-beamforming. Multi-beamforming may focus a radio coverage area by using an array antenna, or may increase the directivity of reception sensitivity in a predetermined direction. A 5G system may use hybrid beamforming (hybrid BF) that combines a digital beamforming (digital BF), which changes a phase and/or amplitude of a signal via digital signal processing, and an analog beamforming (analog BF) that forms analog beams with various beam directions and beam widths by changing a phase and/or amplitude of an analog signal. Hybrid beamforming technology may decrease complexity of implementing beamforming technology and may provide a large antenna gain.

The disclosure is not limited to hybrid beamforming, and may be applicable to various communication systems that use analog beamforming.

A block for processing analog beamforming in a base station may include, in a case of a transmission chain, a plurality of phase shifters (analog phase shifters) connected to each RF chain, power amplifiers (PAs), and an array antenna. The plurality of phase shifters (analog phase shifters) may enable the base station to perform beam sweeping at a wide range angle in a downlink.

A block for processing analog beamforming in the base station may include, in a case of a reception chain, a plurality of phase shifters (analog phase shifters) connected to each RF chain, low noise amplifiers (LNAs), and an array antenna. The plurality of phase shifters (analog phase shifters) may enable the base station to perform beam sweeping at a wide range angle in an uplink.

The array antenna may be connected to a switch for switching between the transmission chain and the reception chain in the base station, and may be used in the transmission chain or reception chain. For beamforming, the plurality of phase shifters may adjust a phase of an RF signal transmitted or received via the array antenna. The array antenna may be combined with a plurality of phase shifters and may implement beamforming. The array antenna may be an array of a plurality of antenna elements, and the array may enable beamforming that may adjust a signal radiation pattern or may focus a signal in a predetermined direction.

In the array antenna, for example, p antenna elements may be disposed in the horizontal direction and q antenna elements may be disposed in the vertical direction in a 2-dimentional plane, and thus 3-dimentional beam adjustment may be performed in horizontal and vertical directions. In this instance, the number of antenna elements configured in the array antenna may be p×q. The array antenna may use various types of antennas capable of performing beam adjustment in horizontal and vertical directions.

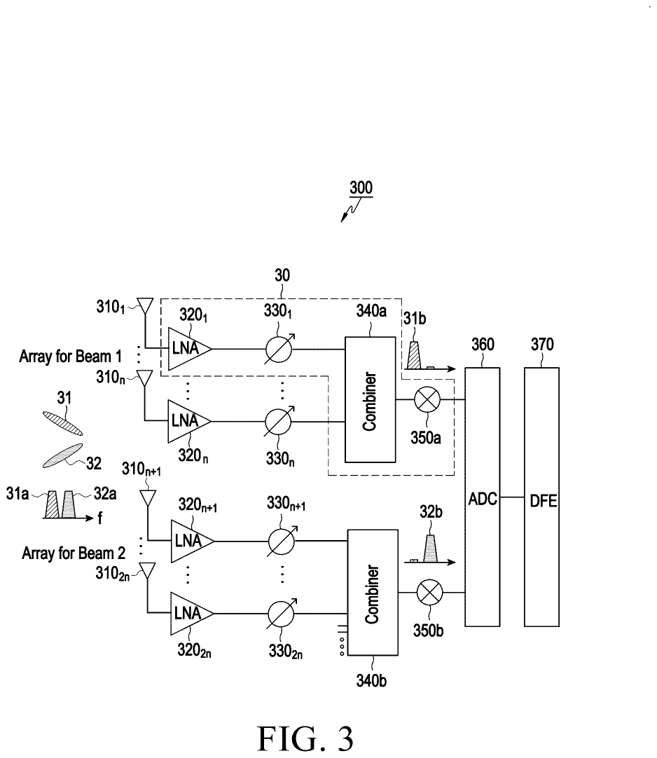

FIG. 3 is a diagram illustrating a configuration example of a reception device of a base station that uses multi-beamforming in a wireless communication system, according to one or more embodiments.

The example of FIG. 3 illustrates a configuration in which a reception device 300 of a base station receives uplink signals respectively from UEs (e.g., first UE and second UE) by using dual beams as multiple beams for ease of description. It is assumed that, in the dual beams, a first reception beam 31 is for receiving an uplink signal 31a of the first UE and a second reception beam 32 is for receiving an uplink signal 32a of the second UE.

Referring to FIG. 3, the reception device 300 of the base station may include an array antenna including a plurality of antenna elements 310₁, . . . , 310ₙ, 310ₙ₊₁, . . . , 310₂ₙ, a radio-frequency integrated circuit (RFIC) or RF chip that operates in a frequency range appropriate for wireless transmission, an analog-to-digital converter (ADC) 360 that converts an analog signal into a digital signal, and a digital front end (DFE) 370 that is in charge of digital signal processing and performs signal filtering, conversion, synchronization, and the like. The RFIC or RF chip may include a plurality of RF chains which may include a plurality of LNAs 320₁, . . . , 320ₙ, 320ₙ₊₁, . . . , 320₂ₙ, a plurality of phase shifters 330₁, . . . , 330ₙ, 330ₙ₊₁, . . . , 330₂ₙ, a plurality of combiners 340a and 340b, and a plurality of mixers 350a and 350b. Although two combiners 340a and 340b and two mixers 350a and 350b are illustrated in FIG. 3 for ease of description, one or more additional combiners and mixers may be included in the reception device 300.

In FIG. 3, each LNA of the 2n LNAs 320₁ to 320₂ₙ may amplify an RF signal received via each antenna element and output an amplified RF signal, and each phase shifter of the 2n phase shifters 330₁ to 330₂ₙ may adjust a phase of the amplified RF signal input from each LNA and output a phase-adjusted RF signal for beamforming. The combiners 340a and 340b may respectively combine the phase-adjusted RF signals and output combined RF signals, and the mixers 350a and 350b may receive the combined RF signals, convert the combined RF signals into a baseband signal and output the baseband signal.

In the reception device 300 of FIG. 3, each antenna element of the array antenna may be connected to a single RF chain. On an assumption that the number of antenna elements included in the array antenna is 2n, n antenna elements corresponding to the first antenna element 310₁ to the n^{th} antenna element 310ₙ, are used for forming the first reception beam 31, and n antenna elements corresponding to the (n+1)^{th} antenna element 310ₙ₊₁ to the 2n^{th} antenna element 310₂ₙ may be used for forming the second reception beam 32. For example, a first RF chain 30 connected to the first antenna element 310₁ in the reception device 300 of FIG. 3 may include the LNA 320₁, the phase shifter 330₁, the combiner 340a, and the mixer 350b. The combiner 340a and the mixer 350a may be shared with at least one other RF chain. In the example of FIG. 3, each RF chain may include a single LNA and a single phase shifter.

In the example of FIG. 3, the reception device 300 may use n antenna elements in the array antenna for forming a single reception beam. In this instance, n RF chains may be required per single reception beam. Therefore, in a multi-beamforming structure that uses dual beams, the reception device 300 of FIG. 3 may require 2n RF chains, and the number of LNAs 320 and mixers 530 included in the 2n RF chains may be increased to twice that of a reception device that uses a single beam. In the same manner, in a multi-beamforming structure that uses four (4) reception beams, a reception device may require 4n RF chains, and the number of LNAs and mixers included in the 4n RF chains may be increased to four (4) times that of the reception device that uses a single beam. In addition, in proportion to increase of the number of reception beams in a multi-beamforming structure, the number of antenna elements required in an array antenna may also be increased.

In the example of FIG. 3, the uplink signal 31a of the first UE received via the first reception beam 31 may be processed in a signal path starting from the first antenna element 310₁ to the n^{th} antenna element 310ₙ and passing through the mixer 350a, and may be converted into a baseband signal. The uplink signal 32a of the second UE received via the second reception beam 32 may be processed in a signal path starting from the (n+1)^{th} antenna element 310ₙ₊₁ to the 2n^{th} antenna element 310₂ₙ and passing through the mixer 350b, and may be converted into a baseband signal.

As illustrated in the structure of FIG. 3, in a reception device of a base station that uses multiple beams, each reception beam independently uses antenna elements and RF chains and may have a high degree of freedom. However, as the number of beams of multiple beams increases, the number of hardware elements such as antenna elements, LNAs required in RF chains, mixers, and the like are increased proportionally. For example, when the number of beams increase twofold, the number of required antenna elements, LNAs, mixers, or the like may also be increased twofold. Thus, the costs of installing the base station may increase, and the amount of power used by the base station may also increase.

In the mmWave band which is a broadband, there may be a case of frequently using a portion of a secured bandwidth in an uplink (UL), as compared with a downlink (DL). In this instance, when multi-beamforming technology is used by performing frequency division of the mmWave band, a base station may simultaneously accommodate a plurality of UEs and may increase a cell-throughput of the base station. However, in the analog beamforming method that is frequently used in the mmWave band, when a base station uses the configuration shown in the example of FIG. 3 in order to implement multi-beamforming, the number of hardware elements such as antenna elements, LNAs, mixers, and the like in a reception device of the base station may be increased in proportion to the number of multiple beams and thus, costs of implementing hardware of the base station and an amount of power consumption may increase. The disclosure proposes a base station structure and an RF chip structure that may reduce the number of hardware elements required by the base station that uses multi-beamforming, and may reduce an area that the hardware elements occupy in the base station.

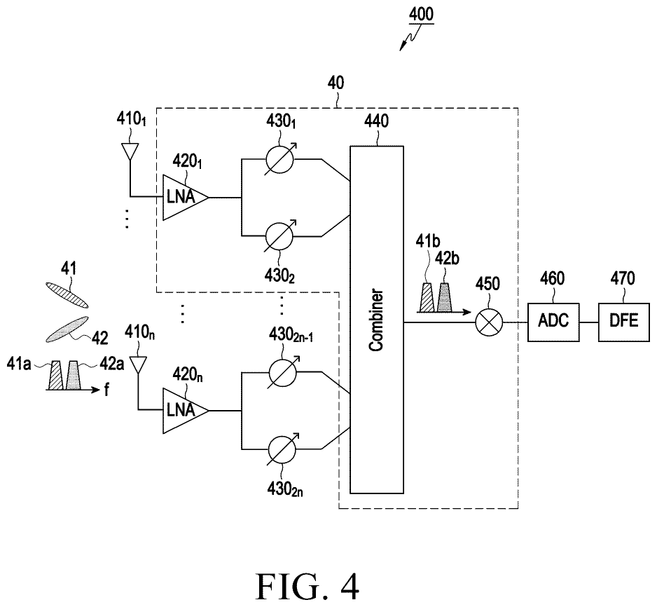

FIG. 4 is a diagram illustrating a configuration example of a reception device of a base station that uses multi-beamforming in a wireless communication system according to one or more embodiments.

The example of FIG. 4 illustrates a configuration in which a reception device 400 of a base station receives uplink signals respectively from UEs (e.g., first UE and second UE) by using dual beams as multiple beams for ease of description. It is assumed that, in the dual beams, a first reception beam 41 is for receiving an uplink signal 41a of the first UE and a second reception beam 42 is for receiving an uplink signal 42a of the second UE. In FIG. 4, a structure of the reception device that uses dual beams may be applied, in the same manner, to a reception device structure using multiple beams, which are two or more reception beams.

Referring to FIG. 4, the reception device 400 of the base station may include an array antenna including n antenna elements 410₁, . . . , 410ₙ, a radio frequency integrated circuit (RFIC) or RF chip)that operates in a frequency range appropriate for wireless transmission, an analog-to-digital converter (ADC) 460 that converts an analog signal into a digital signal, and a digital front end (DFE) 470 that is in charge of digital signal processing and performs filtering, conversion, synchronization, or the like of a received signal. The RFIC or RF chip may include a plurality of RF chains. The plurality of RF chains may include n LNAs 420₁, . . . , 420ₙ, 2n phase shifters 430₁, . . . , 430₂ₙ, a combiner 440, and a mixer 450. Although one combiner 440 and one mixer 450 are illustrated for ease of description, the RFIC or RF chip may include at least one combiner and at least one mixer.

In FIG. 4, each LNA of the n LNAs 420₁, . . . , 420ₙ may amplify an RF signal received via each antenna element and output an amplified RF signal, and the 2n phase shifters 430₁, . . . , 430ₙ may be configured in n sub-sets each of which includes two phase shifters. The two phase shifters of each sub-set may have input ends connected to an output end of a corresponding LNA, and output ends connected to the combiner 440. When the two phase shifters included in each sub-set are referred to as a first phase shifter and a second phase shifter, the first phase shifter may adjust a phase of an RF signal input from the corresponding LNA and may output a phase-adjusted RF signal for beamforming of the first reception beam 41 in dual beams, and the second phase shifter may adjust a phase of an RF signal input from the corresponding LNA and may output a phase-adjusted RF signal for beamforming of the second reception beam 42 in the dual beams. The number of phase shifters included in each sub-set may be increased in proportion to the number of reception beams in multi-beamforming. For example, when the number of reception beams in multi-beamforming is x, the number of phase shifters included in each sub-set may be x. In the structure of FIG. 4, each antenna element and each LNA may be shared by reception beams in dual beams, and signal processing for phase adjustment for the two reception beams may be performed in each sub-set of the phase shifters 430₁, . . . , 430₂ₙ. The combiner 440 may combine RF signals which are phase-adjusted by the phase shifters 430₁, . . . , 430₂ₙ and output the combined RF signals 41b and 42b, and the mixer 450 may receive the combined RF signals output from the combiner 440, may convert the combined RF signals into a baseband signal, and may output the baseband signal.

In the reception device of FIG. 4, each antenna element of the array antenna may be electrically connected to a single RF chain. When it is assumed that the number of antenna elements included in the array antenna is n, each of the n antenna elements corresponding to the first antenna element 410₁ to the n^{th} antenna element 410ₙ may be used together for forming the first reception beam 41 and the second reception beam 42. The structure of FIG. 4 may differ from the structure of FIG. 3 in which each antenna element is independently used for one reception beam. In the reception device 400 of FIG. 4, a first RF chain 40 connected to the first antenna element 410₁ may include the single LNA 420₁, the two phase shifters 430₁ and 430₂ corresponding to dual beams, the combiner 440, and the mixer 450. The combiner 440 and the mixer 450 may be shared with at least one other RF chain. In the example of FIG. 4, the uplink signal 41a of the first UE received via the first reception beam 41 and the uplink signal 42a of the second UE may be processed in a signal path starting from the first antenna element 410₁ to the n^{th} antenna element 410ₙ and passing through the mixer 450 and may be converted into a baseband signal, and phase adjustment for two reception beams may be performed in each sub-set of the phase shifters 430₁, . . . , 430₂ₙ.

Therefore, in the reception device structure of FIG. 4 that uses multi-beamforming, at a minimum, each antenna element and each LNA may be shared between reception beams, and only the number of phase shifters may be increased in proportion to the number of reception beams as compared with the reception device structure of FIG. 3. Accordingly, the number of hardware elements required in a base station may be reduced, installation costs of the base station may be reduced, and an area occupied by the hardware elements in the base station may be decreased.

Although the structure of FIG. 4 is an example of a case of using dual beams as multiple beams, the reception device 400 may be controlled to use a single beam by adjusting a configuration for phase adjustment by the phase shifters 430₁, . . . , 430₂ₙ in the structure of FIG. 4. The reception device 400 of FIG. 4 may include a processor, and the processor may control an overall operation of the reception device 400 of FIG. 4 that receives an uplink signal by selectively/dynamically using a single beam or multiple beams. In the disclosure, the phase shifters 430₁, . . . , 430₂ₙ may be operated by one or more registers in which values for adjusting a phase of a reception beam based on a predetermined angle are set, and the values that may be set in the registers based on the number of simultaneously operated beams (e.g., 1, 2, 4, . . . or the like) may be applied/adjusted/controlled by the processor. In addition, the values that may be set in the registers based on the number of simultaneously operated beams (e.g., 1, 2, 4, . . . , or the like) may be stored in advance in a look-up table for use.

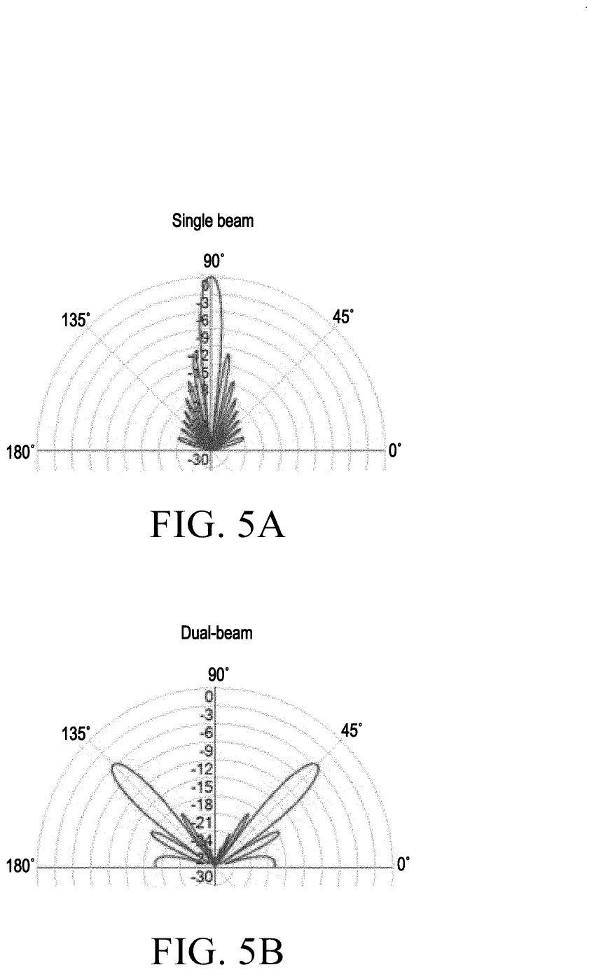

FIGS. 5A and 5B are diagrams illustrating examples of simulation results of a single beam and dual beams in the reception device structure of the base station of FIG. 4 according to one or more embodiments. FIG. 5A illustrates a waveform of a reception beam when the reception device of FIG. 4 forms a single beam, and FIG. 5B illustrates a waveform of two reception beams when dual beams are formed, for example, in directions of +45 degree and −45 degree (i.e., 135 degree). In a case in which dual beams are formed, frequency bands are separated and no (or reduced) interference is given to a counterpart signal in each reception beam.

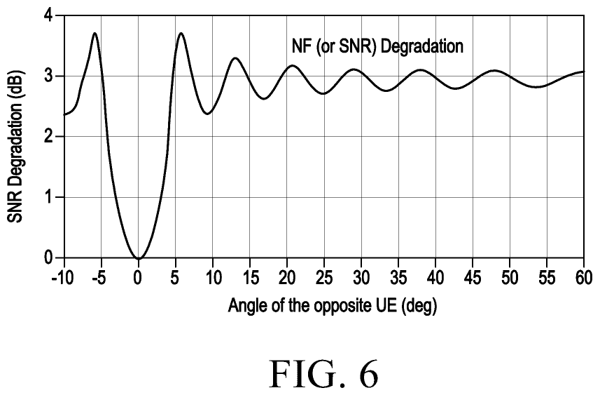

FIG. 6 is a diagram illustrating a simulation result of a signal-to-noise ratio (SNR) degradation degree of a UE1 signal based on UE2's relative position (e.g., an angle of a reception beam) when the reception device structure of the base station of FIG. 4 forms dual beams for UE1 and UE2, which may be or correspond to the first UE and the second UE of the above embodiment, according to one or more embodiments. The example of FIG. 6 assumes a communication environment in which a base station allocates different sub-frequency bands to the UE1 and the UE2, and performs communication simultaneously using the dual beams. The frequency bands allocated to UE1 and UE2 are different, and thus an uplink signal of UE2 does not directly degrade an SNR of an uplink signal of UE1, and an SNR degradation of approximately 3 dB, which is relatively low, may occur in the received signal of UE1. That is, the frequency bands allocated to UE1 and UE2 are different, and thus, although uplink signals of UE1 and UE2 are combined, there may be no direct interference by a counterpart signal.

A base station that uses the structure of FIG. 4 according to one or more embodiments may adaptively apply a single beam and multiple beams according to a communication environment. For example, when a single beam is used, a processor of the base station may apply the same set value to registers of two phase shifters in each sub-set of a plurality of phase shifters, and may control a reception operation via a single beam. When multiple beams are used, the processor of the base station may apply different set values to registers of two phase shifters in each sub-set in order to perform phase adjustment of dual beams, and may control a reception operation via the dual beams. As described above, by adaptively operating a single beam and multiple beams, an SNR degradation of a received signal may be reduced and a cell throughput may increase.

The base station that uses multi-beamforming according to one or more embodiments may use, as a phase shifter, a single ended (SE) phase shifter as shown in the example of FIG. 4, a differential phase shifter that receives a differential signal with a phase difference of 180 degrees from an LNA and outputs a phase-adjusted signal according to multi-beamforming, as in the following embodiments, or a pseudo differential phase shifter. A communication method that uses a differential signal is a communication method in which a reception device restores an original signal based on a difference between two signals by using a signal with an opposite phase, that is, a signal with a phase difference of 180 degrees from the same signal. Each RF chip or RFIC in a communication device such as a base station or the like that uses the mmWave band may be designed using a structure that uses a differential signal. Each RF chip or RFIC that uses a differential signal may provide many advantages of 1) increasing an SNR since common mode rejection is allowed and reducing vulnerability to external noise, 2) allowing a symmetrical design, and 3) reducing harmonic content in an LNA, power amplifier (PA), or the like and increasing linearity.

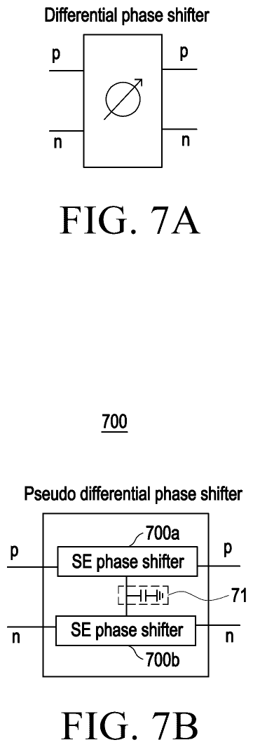

FIG. 7A is a diagram illustrating an example of a differential phase shifter applicable to a base station that uses multi-beamforming according to one or more embodiments. The differential phase shifter of FIG. 7A may output a signal that is phase-adjusted based on a set value for multi-beamforming, with respect to two signals (p, n) with a phase difference of 180 degrees.

FIG. 7B is a diagram illustrating an example of a pseudo differential phase shifter applicable to a base station that uses multi-beamforming according to one or more embodiments. The pseudo differential phase shifter 700 of FIG. 7B may output a signal that is phase-adjusted based on a set value for multi-beamforming, with respect to two signals (p, n) with a phase difference of 180 degrees. The pseudo differential phase shifter may include as many SE phase shifters as the number of beams of multi-beamforming. That is, the pseudo differential phase shifter 700 of FIG. 7B is an example of a configuration including two SE phase shifters 700a and 700b capable of being used for dual beamforming, and the two SE phase shifters 700a and 700b may be connected to alternating current (AC) ground 71 by using a direct current (DC) capacitor. The number of SE phase shifters included in the pseudo differential phase shifter 700 may be increased in proportion to the number of beams in multi-beamforming. The pseudo differential phase shifter 700 of FIG. 7B may operate as the differential phase shifter of FIG. 7A, and in this instance, the AC ground 71 may be omitted.

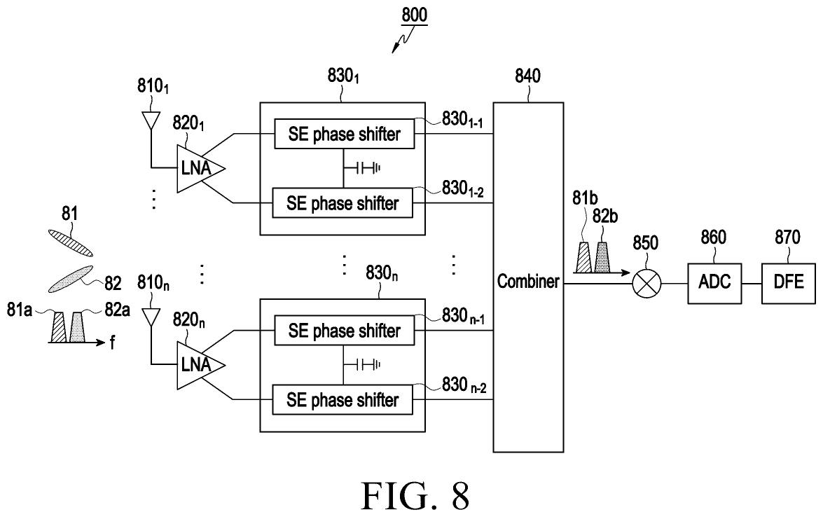

FIG. 8 is a diagram illustrating a configuration example of a reception device of a base station that uses the pseudo differential phase shifter of FIG. 7B for multi-beamforming in a wireless communication system according to one or more embodiments.

The example of FIG. 8 illustrates a configuration in which a reception device 800 of a base station receives uplink signals respectively from UEs (e.g., first UE and second UE) by using dual beams as multiple beams for ease of description. It is assumed that, in the dual beams, a first reception beam 81 is for receiving an uplink signal 81a of the first UE and a second reception beam 82 is for receiving an uplink signal 82a of the second UE. In FIG. 8, a structure of the reception device 800 that uses dual beams may be applied, in the same manner, to a reception device structure using multiple beams, which are two or more reception beams.

Referring to FIG. 8, the reception device 800 of the base station may include an array antenna including n antenna elements 810₁, . . . , 810ₙ, a radio frequency integrated circuit (RFIC) or RF chip that operates in a frequency range appropriate for wireless transmission, an analog-to-digital converter (ADC) 860 that converts an analog signal into a digital signal, and a digital front end (DFE) 870 that is in charge of digital signal processing and performs filtering, conversion, synchronization, or the like of a received signal. The RFIC or RF chip may include a plurality of RF chains. The plurality of RF chains may include n LNAs 820₁, . . . , 820ₙ that output differential signals with 180-degree phase differences, n pseudo differential phase shifters 830₁, . . . , 830ₙ, a combiner 840, and a mixer 850. Although one combiner 840 and one mixer 850 are illustrated for ease of description, the RFIC or RF chip may include at least one combiner and at least one mixer.

In FIG. 8, each LNA of the n LNAs 820₁, . . . , 820ₙ may amplify an RF signal received via each antenna element and output a differential signal, and the n pseudo differential phase shifters 830₁, . . . , 830ₙ may be configured in n sub-sets each of which, that is, each pseudo differential phase shifter, includes two phase shifters. The two SE phase shifters of each pseudo differential phase shifter (or sub-set) may have input ends connected to output ends of a corresponding LNA, and have output ends connected to an input end of the combiner 840. When the two phase shifters included in each pseudo differential phase shifter (sub-set) are referred to as a first SE phase shifter and a second SE phase shifter, the first SE phase shifter may adjust a phase of an RF signal input from a corresponding LNA for beamforming of the first reception beam 81 in dual beams and output a phase-adjusted RF signal, and the second SE phase shifter may adjust a phase of an RF signal input from the corresponding LNA for beamforming of the second reception beam 82 in the dual beams and output a phase-adjusted RF signal. The number of SE phase shifters included in each pseudo differential phase shifter (or sub-set) may be increased to correspond to the number of reception beams in multi-beamforming. For example, when the number of reception beams in multi-beamforming is x, the number of SE phase shifters included in each pseudo differential phase shifter (or sub-set) may be x. In the structure of FIG. 8, each antenna element and each LNA may be shared by reception beams in dual beams, and signal processing for phase adjustment for the two reception beams may be performed in each pseudo differential phase shifter (or sub-set) of the pseudo differential phase shifters 830₁, . . . , 830ₙ. The combiner 840 may combine RF signals which are phase-adjusted by the pseudo differential phase shifters 830₁, . . . , 830ₙ and output the combined RF signals 81b and 82b, and the mixer 850 may receive the combined RF signals output from the combiner 840, may convert the combined RF signals into a baseband signal, and may output the baseband signal.

In the reception device 800 of FIG. 8, each antenna element of the array antenna may be electrically connected to a single RF chain. When it is assumed that the number of antenna elements included in the array antenna is n, n antenna elements corresponding to the first antenna element 810₁ to the n^{th} antenna element 810ₙ may be used together for forming the first reception beam 81 and the second reception beam 82. The structure of FIG. 8 may differ from the structure of FIG. 3 in which each antenna element is independently used for one reception beam. In the reception device 800 of FIG. 8, a first RF chain connected to the first antenna element 810₁ may include the single LNA 820₁, the two SE phase shifters 830₁₋₁ and 830₁₋₂ corresponding to dual beams, the combiner 840, and the mixer 850. The combiner 840 and the mixer 850 may be shared with at least one other RF chain. In the example of FIG. 8, the uplink signal 81a of the first UE and the uplink signal 82a of the second UE, which are received via the first and second reception beams 81 and 82, may be processed in a signal path starting from the first antenna element 810₁ to the n^{th} antenna element 810ₙ and passing through the mixer 850, and may be converted into a baseband signal, and phase adjustment for two reception beams may be performed in each pseudo differential phase shifter (or sub-set) of the pseudo differential phase shifters 830₁, . . . , 830ₙ.

Therefore, in the reception device structure of FIG. 8 that uses multi-beamforming, at a minimum, each antenna element and each LNA may be shared between reception beams, and only the number of phase shifters may be increased in proportion to the number of reception beams. Accordingly, as compared with the reception device structure of FIG. 3, the number of hardware elements required in a base station may be reduced, installation costs of the base station may be reduced, and an area occupied by the hardware elements in the base station may be decreased.

Although the structure of FIG. 8 is an example of a case of using dual beams as multiple beams, the reception device 800 may be controlled to use a single beam by adjusting a configuration for phase adjustment by the pseudo differential phase shifters 830₁, . . . , 830ₙ in the structure of FIG. 8. The reception device 800 of FIG. 8 may include a processor, and the processor may control an overall operation of the reception device 800 of FIG. 8 that receives an uplink signal using a single beam or multiple beams. In the disclosure, the pseudo differential phase shifters 830₁, . . . , 830ₙ may be operated by one or more registers in which values for adjusting a phase of a reception beam based on a predetermined angle are set, and a values that may be set in the registers based on the number of simultaneously operated beams (e.g., 1, 2, 4, . . . or the like) may be applied/adjusted/controlled by the processor. In addition, the values that may be set in the registers based on the number of simultaneously operated beams (e.g., 1, 2, 4, . . . , or the like) may be stored in advance in a look-up table for use.

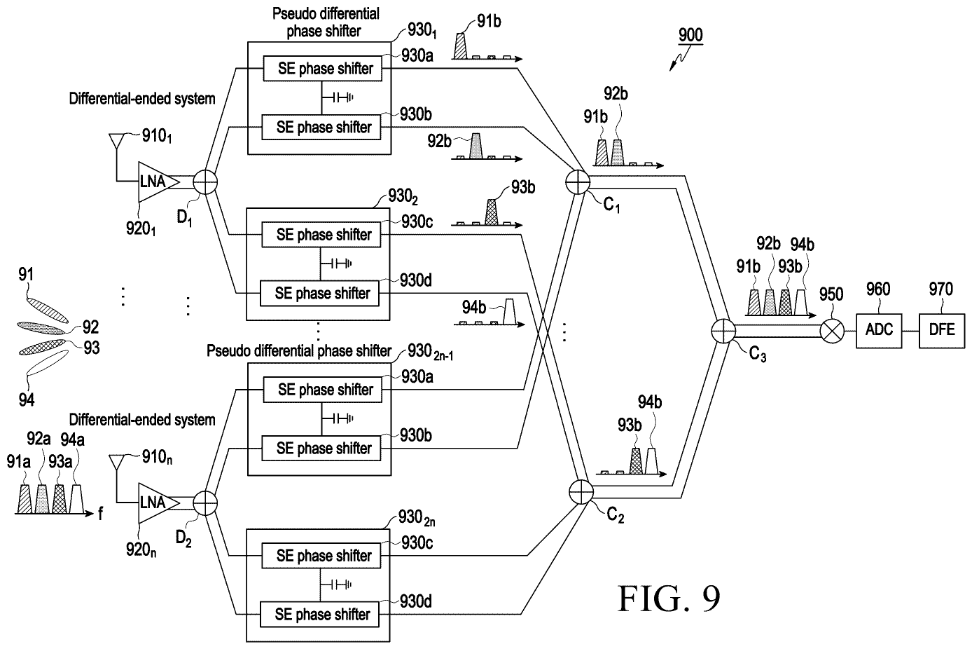

FIG. 9 is a diagram illustrating a configuration example of a reception device of a base station that uses the pseudo differential phase shifter of FIG. 7B for multi-beamforming in a wireless communication system according to one or more embodiments.

The example of FIG. 9 illustrates a configuration in which a reception device 900 of a base station receives uplink signals respectively from UEs (e.g., first UE to fourth UE) by using four beams as multiple beams for ease of description. It is assumed that a first reception beam 91 is for receiving an uplink signal 91a of the first UE, a second reception beam 92 is for receiving an uplink signal 92a of a second UE, a third reception beam 93 is for receiving an uplink signal 93a of a third UE, and a fourth reception beam 94 is for receiving an uplink signal 94a of a fourth UE. In FIG. 9, a structure of the reception device that uses four beams may be applied, in the same manner, to a reception device structure using multiple beams, which are four or more reception beams.

Referring to FIG. 9, the reception device 900 of the base station may include an array antenna including n antenna elements 910₁, . . . , 910ₙ, a radio frequency integrated circuit (RFIC) or RF chip that operates in a frequency range appropriate for wireless transmission, an analog-to-digital converter (ADC) 960 that converts an analog signal into a digital signal, and a digital front end (DFE) 970 that is in charge of digital signal processing and performs filtering, conversion, synchronization, or the like of a received signal. The RFIC or RF chip may include a plurality of RF chains. The plurality of RF chains may include n LNAs 920₁, . . . , 920ₙ that output differential signals with 180-degree phase differences, a plurality of distributers D₁, . . . , D₂, 2n pseudo differential phase shifters 930₁, . . . , 930₂ₙ, a plurality of combiners C1, C2, . . . C3, and a mixer 950. The number of at least one of the plurality of distributers D₁, . . . , D₂ and combiners C1, C2, . . . , C3 may change based on a method/sequence of distributing/combining RF signals input/output from the pseudo differential phase shifters 930. Here, a connection method (i.e., distributing/combining method) of the plurality of distributers D₁, . . . , D₂ and combiners C1, C2, . . . , C3 is not limited to the connection example of FIG. 9, and may change to one of the various connection types that distribute/combine RF signals for each reception beam for output. The RFIC or RF chip may include at least one distributer, at least one combiner, and at least one mixer.

In FIG. 9, each LNA of the n LNAs 920₁, . . . , 920ₙ may amplify an RF signal received via each antenna element and output a differential signal, and the differential signal may be divided, by a distributer in each RF chain, as reception beam-based signals and input into 2n pseudo differential phase shifters 930₁, . . . , 930₂ₙ. For example, referring to FIG. 9, a differential signal output from the LNA 920₁ in an RF chain that the LNA 920₁ belongs to may be separated as reception beam-based signals of the first reception beam 91 to the fourth reception beam 94 via the distributer D₁, and may be input into the first and second pseudo differential phase shifters 930₁ and 930₂ (or sub-set). Each of the first and second pseudo differential phase shifters 930₁ and 930₂ may include two SE phase shifters. The first pseudo differential phase shifter 930₁ may include a first SE phase shifter 930a and a second SE phase shifter 930b, and the second pseudo differential phase shifter 930₂ may include a third SE phase shifter 930c and a fourth SE phase shifter 930d. Specifically, the first SE phase shifter 930a may adjust a phase of an RF signal input from the LNA 920₁ via the distributer D₁ and output a phase-adjusted RF signal 91b, for beamforming of the first reception beam 91, the second SE phase shifter 930b may adjust a phase of an RF signal input from the LNA 920₁ via the distributer D₁ and output a phase-adjusted RF signal 92b, for beamforming of the second reception beam 92, the third SE phase shifter 930c may adjust a phase of an RF signal input from the LNA 920₁ via the distributer D₁ and output a phase-adjusted RF signal 93b, for beamforming of the third reception beam 93, and the fourth SE phase shifter 930d may adjust a phase of an RF signal input from the LNA 920₁ via the distributer D₁ and output a phase-adjusted RF signal 94b, for beamforming of the fourth reception beam 94. The number of SE phase shifters included in a sub-set of the pseudo differential phase shifters 930₁, . . . , 930₂ₙ in a single RF chain may be increased to correspond to the number of reception beams in multi-beamforming. For example, when the number of reception beams in multi-beamforming is x, the number of SE phase shifters included in each sub-set of the pseudo differential phase shifters may be x. In the structure of FIG. 9, each antenna element and each LNA may be shared by reception beams in multiple beams, and signal processing for phase adjustment for each reception beam may be performed in each sub-set of the pseudo differential phase shifters 930₁, . . . , 930₂ₙ. Each of the plurality of RF chains may have a structure identical to the one RF chain. The plurality of combiners C1, C2, . . . , C3 may combine RF signals of which phases are adjusted by the pseudo differential phase shifters 930₁, . . . , 930₂ₙ and output the combined RF signals 91b, 92b, 93b, and 94b, and the mixer 950 may convert the combined RF signals into a baseband signal and output the baseband signal. The method of connecting the plurality of combiners C1, C2, . . . , C3 is not limited to the connection example of FIG. 9, but may be changed to one of the various connection types that may combine RF signals of which phases are adjusted for each reception beam, and may perform combined RF signals.

In the reception device 900 of FIG. 9, each antenna element of the array antenna may be electrically connected to a single RF chain. When it is assumed that the number of antenna elements included in the array antenna is n, n antenna elements corresponding to the first antenna element 910₁ to the n^{th} antenna element 910ₙ may be used together for forming the first reception beam 91 and the fourth reception beam 94. The structure of FIG. 9 may differ from the structure of FIG. 3 in which each antenna element is independently used for one reception beam. A first RF chain connected to the first antenna element 910₁ in the reception device 900 of FIG. 9 may include the single LNA 920₁, a single sub-set (e.g., four (4) SE phase shifters 930a, 930b, 930c, 930d) of pseudo differential phase shifters corresponding to four reception beams, the combiners C1, C2, . . . , C3, and the mixer 950. The combiners C1, C2, . . . , C3 and the mixer 950 may be shared with at least one other RF chain. In the example of FIG. 9, the uplink signals 91a, 92a, 93a, and 94a of the first to fourth uplink signals of the first UE received via the first to fourth reception beams 91, 92, 93, and 94 may be processed in a signal path starting from the first antenna element 910₁ to the n^{th} antenna element 910ₙ and passing through the mixer 950, and may be converted into a baseband signal, and phase adjustment for each reception beam may be performed in each sub-set of the pseudo differential phase shifters 930₁, . . . , 930₂ₙ.

Therefore, in the reception device structure of FIG. 9 that uses multi-beamforming, at a minimum, each antenna element and each LNA may be shared between reception beams, and only the number of phase shifters may be increased in proportion to the number of reception beams. Accordingly, as compared with the reception device structure of FIG. 3, the number of hardware elements required in a base station may be reduced, installation costs of the base station may be reduced, and an area occupied by the hardware elements in the base station may be decreased.

Although the structure of FIG. 9 is an example of a case of using quadruple beams as multiple beams, the reception device may be controlled to use a single beam by adjusting a configuration for phase adjustment by the pseudo differential phase shifters 930₁, . . . , 930₂ₙ in the structure of FIG. 9. The reception device 900 of FIG. 9 may include a processor that is not illustrated, and the processor may control an overall operation of the reception device 900 of FIG. 9 that receives an uplink signal using a single beam or multiple beams. In the disclosure, the pseudo differential phase shifters 930₁, . . . , 930₂ₙ may be operated by one or more registers in which values for adjusting a phase of a reception beam based on a predetermined angle are configured, and a configuration value(s) that may be set in the one or more registers based on the number of simultaneously operated beams (e.g., 1, 2, 4, . . . or the like) may be applied/adjusted/controlled by the processor. In addition, the values that may be set in the registers based on the number of simultaneously operated beams (e.g., 1, 2, 4, . . . , or the like) may be stored in advance in a look-up table for use.

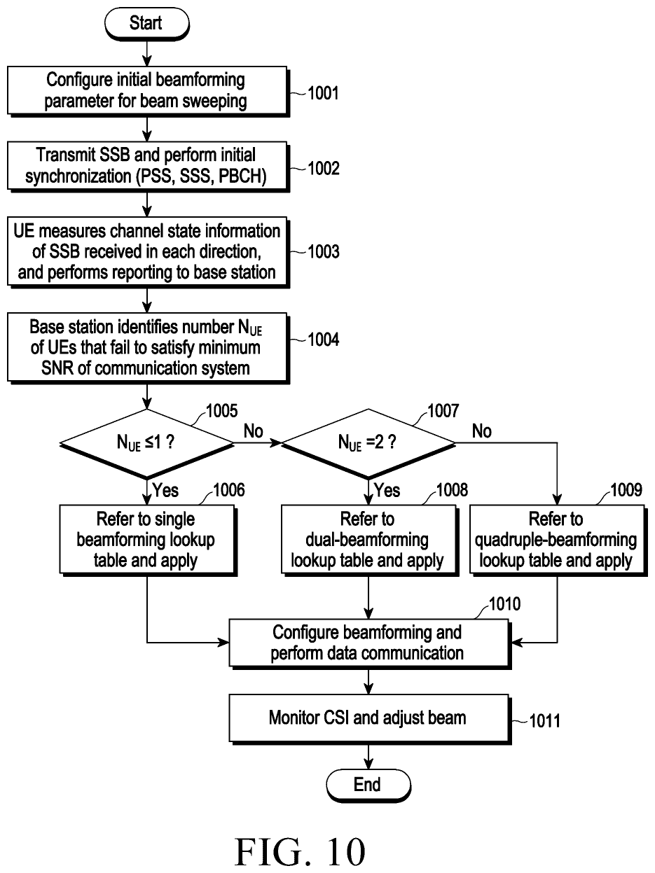

FIG. 10 is a diagram illustrating an example of a method performed in a reception device of a base station that uses multi-beamforming in a wireless communication system according to one or more embodiments.

The method of FIG. 10 may be performed in a base station with a configuration of FIG. 4, FIG. 8, and/or FIG. 9, and a processor of the base station may control an overall operation of the base station in order to implement the method of FIG. 10. For example, the processor of the base station may determine the number (N_{UE}) of UEs that deviate from/fail to satisfy a critical SNR which is a minimum signal-to-noise ratio (SNR) value to ensure the performance of a communication system or the number (N_{UE}) of UEs that have channel communication states lower than a critical SNR. After determining whether the number (N_{UE}) of the UEs is greater than or equal to, for example, 1, 2, or 4, the processor may refer to a lookup table including register set values of phase shifters in the configuration of FIG. 4, FIG. 8, and/or FIG. 9, and may apply/adjust/control the register set values based on a single or multi-beamforming operation.

Referring to FIG. 10, in operation 1001, the base station may configure initial beamforming parameters for beam sweeping. In operation 1002, the base station may transmit/transfer a synchronization signal block (SSB) including, for example, a primary synchronization signal (PSS), a secondary synchronization signal (SSS), and a physical broadcast channel (PBCH), which are well known, in a 5G system, and may perform (initial) uplink synchronization with a UE. The SSB may be transmitted in each direction according to a beam sweeping operation of the base station.

In operation 1003, the base station may receive channel state information from a UE that receives an SSB in each beam direction. In operation 1004, the base station may identify the number (N_{UE}) of UEs that fail to satisfy the minimum SNR. When the number of the UEs is less than or equal to 1 in operation 1005 (i.e., Yes), the base station may identify register set values of phase shifters for single beamforming and may apply the same in operation 1006. When the number of the UEs exceeds 1 in operation 1005 (i.e., No), the base station may identify whether the number (N_{UE}) of the UEs is greater than or equal to 2 in operation 1007. When the number (N_{UE}) of the UEs is 2 in operation 1007 (i.e., Yes), the base station may identify register set values of the phase shifters for dual beamforming and may apply the same in operation 1008. When the number (N_{UE}) of the UEs is greater than 2 in operation 1007 (i.e., No), the base station may identify register configuration values of the phase shifters for quadruple beamforming or more and may apply the same in operation 1009.

In operation 1006, 1008, or 1009, when the register set values of the phase shifters for single or multi-beamforming is identified, the base station may perform data communication using single or multiple beams via operations of the phase shifters to which the set values for single or multi-beamforming is applied in operation 1010. Subsequently, in operation 1011, the base station may monitor channel state information (CSI) received from a UE, and may adjust one or more beams for single or multi-beamforming.

In a transmission device of the base station, the method of FIG. 10 may be modified and performed also in a manner of identifying downlink channel state information and performing single or multi-beamforming in the same/similar way based on the identified number of UEs that fail to satisfy a minimum/critical SNR in the downlink.

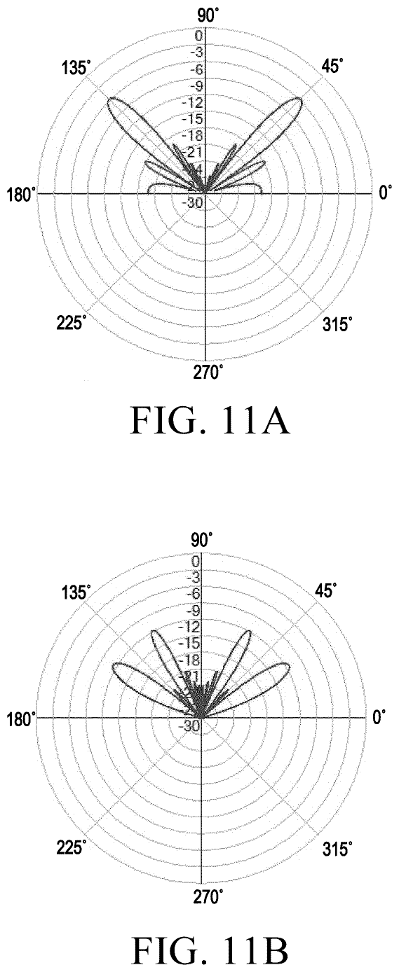

FIGS. 11A and 11B are diagrams illustrating examples of simulation results of dual beams and quadruple beams in a reception device structure of a base station according to one or more embodiments. FIG. 11A illustrates a simulation result that forms dual beams (e.g., −45 degrees/45 degrees) by using a lookup table including set values of registers for operation of a (pseudo) differential phase shifter, for example, when the number (N_{UE}) of UEs identified according to the method of FIG. 10 is two (2) in a base station with a configuration for multi-beamforming of FIG. 4, FIG. 8, and/or FIG. 9. FIG. 11B illustrates a simulation result that forms quadruple beams (e.g., −60 degrees/−30 degrees/30 degrees/60 degrees) by using a lookup table including set values of registers for operation of a (pseudo) differential phase shifter, for example, when the number (N_{UE}) of UEs identified according to the method of FIG. 10 is four (4) in a base station with a configuration for multi-beamforming of FIG. 4, FIG. 8, and/or FIG. 9. The base station may simultaneously perform communication with a plurality of UEs without signal interference or with reduced interference by using multiple beams formed via multi-beamforming according to the simulation results of FIG. 11A and FIG. 11B.

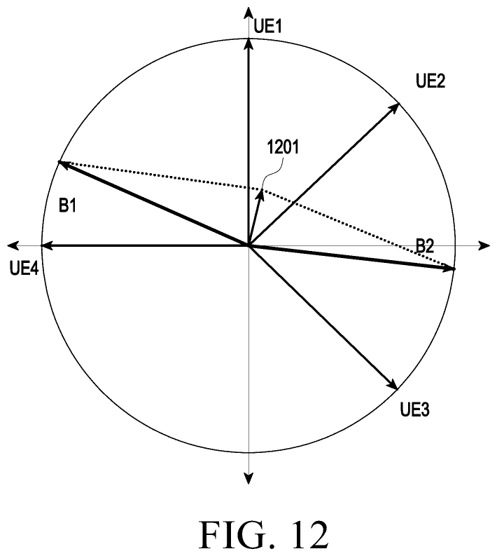

FIG. 12 is a diagram illustrating an example of a method of approximating a resultant vector of multiple beams as a sum of two vectors, for multi-beamforming in a wireless communication system according to one or more embodiments.

Referring to FIG. 12, when the number (N_{UE}) of UEs identified according to the method of FIG. 10 is, for example, four (4) (e.g., UE1, UE2, UE3, UE4) in a base station that includes phase shifters for multi-beamforming of FIG. 4, FIG. 8, and/or FIG. 9, a method of approximating a total sum 1201 of vectors of a beam book corresponding to each UE as a sum of two vectors (B1+B2) according to a predetermined logic/algorithm, is illustrated. The example of FIG. 12 illustrates a method of approximating a sum of four angle vectors as a sum of two vectors (B1+B2) when angles required by phase shifters for UE2, UE1, UE4, and UE3 are 45, 90, 180, and 315, respectively. The method of approximating a resultant vector associated with the multiple beams as a sum of two vectors may be implemented in a manner of storing set values of phase shifters to correspond to a resultant vector in advance in a lookup table.

The method of approximating a resultant vector associated with multiple beams as a sum of two vectors in FIG. 12 may be selectively applied to the embodiment of FIG. 4, FIG. 8, and/or FIG. 9. The following description describes an example of forming reception beams in a base station, and the method that approximates a resultant vector of multiple beams as a sum of two vectors may be applied to transmission beam formation in the same manner.

For example, in a case of an operation of receiving uplink signals of four (4) UEs from UE1 to UE4 in the base station structure of FIG. 9, without applying the method of FIG. 12, the base station may form four (4) reception beams for receiving uplink signals of UE1 to UE4. To form four (4) reception beams, reception beam-based phase values may be applied to first to fourth SE phase shifters 930a, 930b, 930c, and 930d corresponding to the number of reception beams in each RF chain of the base station structure of FIG. 9. RF signals of which the phases are adjusted via the first to fourth SE phase shifters 930a, 930b, 930c, and 930d may be output as a signal of a resultant vector (C) as shown by the reference number 1201 of FIG. 12 via the combiners C1, C2 and C3. When the method of FIG. 12 is not applied, predetermined set values of a beam book, configured in advance for phase adjustment in each of the first to fourth SE phase shifters 930a, 930b, 930c, and 930d for each beam angle of the four reception beams (i.e., a set of register set values to be applied to phase shifters of a plurality of RF chains) in each RF chain, may be used.

For example, in a case of an operation of receiving uplink signals of four (4) UEs from UE1 to UE4 in the base station structure of FIG. 9 by applying the method of FIG. 12, the base station may form four (4) reception beams for receiving uplink signals of UE1 to UE4. Here, a method of approximating the resultant vector 1201 for the four (4) reception beams as a sum of two vectors (B1+B2) to form the four (4) reception beams may be used, and the resultant vector 1201 may correspond to a signal output via the combiners C1, C2 and C3. Phase values applied to the first to fourth SE phase shifters 930a, 930b, 930c, 930d in each RF chain of the base station may be expressed in vector forms with the same magnitude and different phases. In FIG. 12, the vectors illustrated at UE1, UE2, UE3, and UE4 may be expressed as a signal of a resultant vector (C) output at the end of each RF chain via the combiners C1, C2, and C3. Every vector is capable of being expressed as a sum of two vectors, the resultant vector (C) may be expressed as a sum of two vectors (B1+B2). Therefore, the 4 vectors of signals of which the phases are adjusted and output from the first to fourth SE phase shifters 930a, 930b, 930c, and 930d may be expressed as the sum of two vectors (B1+B2) corresponding to a resultant vector (C). As described above, by applying the method of FIG. 12 to the base station structure of FIG. 9, the method may express the sum of two vectors (B1+B2) corresponding to the resultant vector (C) by using two phase shifters. To this end, for example, the same register value may be set for the first and second SE phase shifters 930a and 930b for phase adjustment corresponding to the vector B1 and the same register value may be configured for the third and fourth SE phase shifters 930c and 930d for phase adjustment corresponding to the vector B2. As another example, the same register value may be set for the first and third SE phase shifters 930a and 930c for phase adjustment corresponding to the vector B1 and the same register value may be set for the second and fourth SE phase shifters 930b and 930d for phase adjustment corresponding to the vector B2.

The method of FIG. 12 shows that a sum of vector signals that pass through four phase shifters may be expressed as a sum of vector signals that pass through two phase shifters. Although values configured in advance in a previously configured beam book (i.e., a set of register set values to be applied to phase shifters of a plurality of RF chains) for phase adjustment are also used in the method of FIG. 12, two vectors B and B2 may be calculated in advance for a predicted output signal, which is a result of composition (C) of vectors, for each beam direction (or beam direction combination), may be stored as table information, and may be used for multi-beamforming in a base station. As described above, by using the method of FIG. 12, complexity of register setting for phase shifters in each RF chain may decrease when multi-beamforming is performed. For example, by using only setting for two vectors B and B2 for phase shifters in each chain, phase adjustment may be performed when multi-beamforming is performed. The number of RF chains may be, for example, 32, or fewer or more than 32.

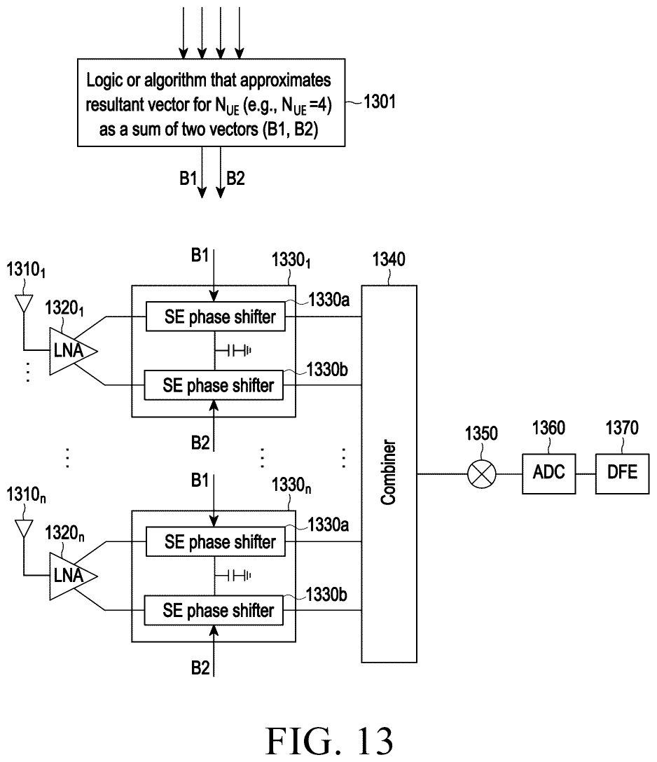

FIG. 13 is a diagram illustrating a configuration example of a reception device of a base station for multi-beamforming in a wireless communication system to which the method of FIG. 12 is applied, according to one or more embodiments.

Referring to FIG. 13, the reception device of the base station may use a configuration similar to the reception device of the base station that has been described with reference to FIG. 8.

The example of FIG. 13 illustrates that the reception device of the base station receives uplink signals respectively from UEs using multiple beams, and shows use 1301 of a method of approximating a result vector for the reception beams of UEs as a sum of two vector B1 and B2 when the number of UEs in the method of FIG. 12 is, for example, N_{UE} (e.g., 4).

Referring to FIG. 13, the reception device of the base station may include an array antenna including n antenna elements 1310₁, . . . , 1310ₙ, a radio frequency integrated circuit (RFIC) or RF chip that operates in a frequency range appropriate for wireless transmission, an analog-to-digital converter (ADC) 1360 that converts an analog signal into a digital signal, and a digital front end (DFE) 1370 that is in charge of digital signal processing and performs filtering, conversion, synchronization, or the like of a received signal. The RFIC or RF chip may include a plurality of RF chains. The plurality of RF chains may include n LNAs 1320₁, . . . , 1320ₙ that output differential signals with 180-degree phase differences, n pseudo differential phase shifters 1330₁, . . . , 1330ₙ, a combiner 1340, and a mixer 1350. Although one combiner 1340 and one mixer 1350 are illustrated for ease of description, the RFIC or RF chip may include at least one combiner and at least one mixer. As described in the example of FIG. 8, also in the example of FIG. 13, n pseudo differential phase shifters 1330₁, . . . , 1330ₙ may be configured with n sub-sets each of which, that is, each pseudo differential phase shifter, includes two SE phase shifters 1330a and 1330b. When the number of reception beams in multi-beamforming is x, the number of SE phase shifters included in each pseudo differential phase shifter (or sub-set) may be x. In the structure of FIG. 13, each antenna element and each LNA may be shared by reception beams in multiple beams, and signal processing for phase adjustment for two reception beams may be performed in each pseudo differential phase shifter (or sub-set) of the pseudo differential phase shifters 1330₁, . . . , 1330ₙ.

In the examples of FIGS. 3 to 13, a configuration of a reception device of a base station including phase shifters for multi-beamforming and a method performed in the base station may be applied to a configuration of a transmission device of the base station and a method performed in the base station in the same or similar manner.

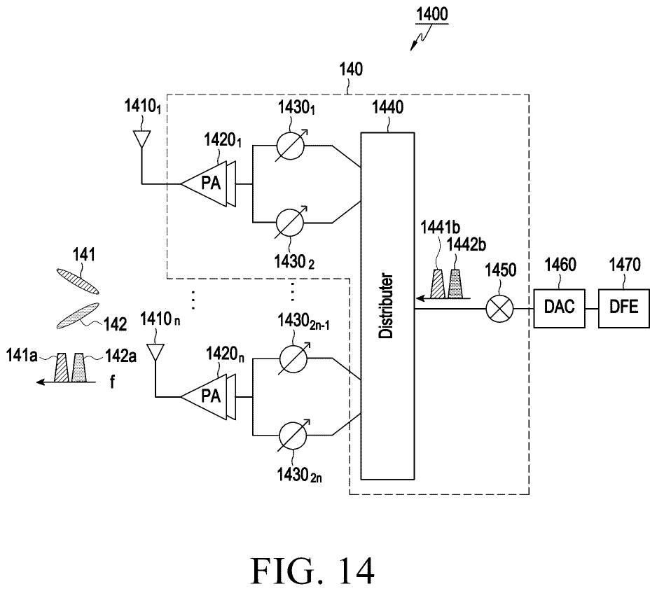

FIG. 14 is a diagram illustrating a configuration example of a transmission device of a base station that uses multi-beamforming in a wireless communication system according to one or more embodiments.

The example of FIG. 14 illustrates a configuration in which a transmission device 1400 of a base station transmits downlink signals respectively to UEs (e.g., first UE and second UE) by using dual beams as multiple beams for ease of description. It is assumed that, in the dual beams, a first transmission beam 141 is for transmitting a downlink signal 141a of the first UE and a second transmission beam 142 is for transmitting a downlink signal 142a of the second UE. In FIG. 4, a structure of the transmission device that uses dual beams may be applied to a transmission device structure using multiple beams, which are two or more transmission beams, in the same manner.

Referring to FIG. 14, the transmission device 1400 of the base station may include an array antenna including n antenna elements 1410₁, . . . , 1410ₙ, a radio frequency integrated circuit (RFIC) or RF chip that operates in a frequency range appropriate for wireless transmission, a digital-to-analog converter (DAC) 1460 that converts a digital signal into an analog signal, and a digital front end (DFE) 1470 that is in charge of digital signal processing and performs filtering, conversion, synchronization, or the like of a received signal. The RFIC or RF chip may include a plurality of RF chains. The plurality of RF chains may include n power amplifiers (PAs) 1420₁, . . . , 1420ₙ, 2n phase shifters 1430₁, . . . , 1430₂ₙ, a distributer 1440, and a mixer 1450. Although one distributer 1440 and one mixer 1450 are illustrated for ease of description, the RFIC or RF chip may include at least one distributer and at least one mixer.

In FIG. 14, each PA of the n PAs 1420₁, . . . , 1420ₙ may amplify an RF signal transmitted via each antenna element and output an amplified RF signal, and the 2n phase shifters 1430₁, . . . , 1430₂ₙ may be configured in n sub-sets each of which includes two phase shifters. The two phase shifters of each sub-set may have output ends connected to an input end of the corresponding PA, and may have input ends connected to an output end of the distributer 1440. When the two phase shifters included in each sub-set are referred to as a first phase shifter and a second phase shifter, the first phase shifter may adjust a phase of an RF signal output to the corresponding PA for beamforming of the first transmission beam 141 in dual beams and may output a phase-adjusted RF signal, and the second phase shifter may adjust a phase of an RF signal output to the corresponding PA for beamforming of the second transmission beam 142 in the dual beams, and output phase-adjusted RF signal. The number of phase shifters included in each sub-set may be increased to correspond to the number of transmission beams in multi-beamforming. For example, when the number of transmission beams in multi-beamforming is x, the number of phase shifters included in each sub-set may be x. In the structure of FIG. 14, each antenna element and each PA may be shared by transmission beams in dual beams, and signal processing for phase adjustment for two transmission beams may be performed in each sub-set of the phase shifters 1430₁, . . . , 1430₂ₙ. The distributer 1440 may distribute and output RF signals 1441b and 1442b for phase adjustment for each transmission beam in the phase shifters 1430₁, . . . , 1430₂ₙ, and the mixer 1450 may receive a baseband signal output from the DFE 1470, may convert the same into RF signals, and may output the RF signals.

In the transmission device of FIG. 14, each antenna element of the array antenna may be electrically connected to a single RF chain. When it is assumed that the number of antenna elements included in the array antenna is n, n antenna elements corresponding to the first antenna element 1410₁ to the n^{th} antenna element 1410ₙ may be used together for forming the first transmission beam 141 and the second transmission beam 142. The structure of FIG. 14 may be different from the structure of an existing transmission device corresponding to FIG. 3 in which each antenna element is independently used for each transmission beam. In the transmission device of FIG. 14, a first RF chain 140 connected to the first antenna element 1410₁ may include the single PA 1420₁, the two phase shifters 1430₁ and 1430₂ corresponding to dual beams, the distributer 1440, and the mixer 1450. The distributer 1440 and the mixer 1450 may be shared with at least one other RF chain. In the example of FIG. 14, the downlink signal 141a of the first UE transmitted via the first transmission beam 141 and the downlink signal 142a of the second UE may be processed in a signal path starting from the mixer 450 and passing through the first antenna element 1410₁ to the n^{th} antenna element 1410ₙ, and may be converted into an RF signal, and phase adjustment for each transmission beam may be performed in each sub-set of the phase shifters 1430₁, . . . , 1430₂ₙ.

Therefore, in the transmission device structure of FIG. 14 that uses multi-beamforming, at a minimum, each antenna element and each LNA may be shared between transmission beams, and only the number of phase shifters may be increased in proportion to the number of transmission beams as compared with the existing transmission device structure. Accordingly, the number of hardware elements required in a base station may be reduced, installation costs of the base station may be reduced, and an area occupied by the hardware elements in the base station may be decreased.

Although the structure of FIG. 14 is an example of a case of using dual beams as multiple beams, the transmission device may be controlled to use a single beam by adjusting a configuration for phase adjustment by the phase shifters 1430₁, . . . , 1430₂ₙ in the structure of FIG. 14. The transmission device of FIG. 14 may include a processor, and the processor may control an overall operation of the transmission device of FIG. 14 that transmits a downlink signal by selectively/dynamically using a single beam or multiple beams. In the disclosure, the phase shifters 1430₁, . . . , 1430₂ₙ may be operated by one or more registers in which values for adjusting a phase of a transmission beam based on a predetermined angle are configured, and set values that may be configured in the registers based on the number of simultaneously operated beams (e.g., 1, 2, 4, . . . or the like) may be applied/adjusted/controlled by the processor. In addition, the values that may be set in the registers based on the number of simultaneously operated beams (e.g., 1, 2, 4, . . . , or the like) may be stored in advance in a look-up table for use.

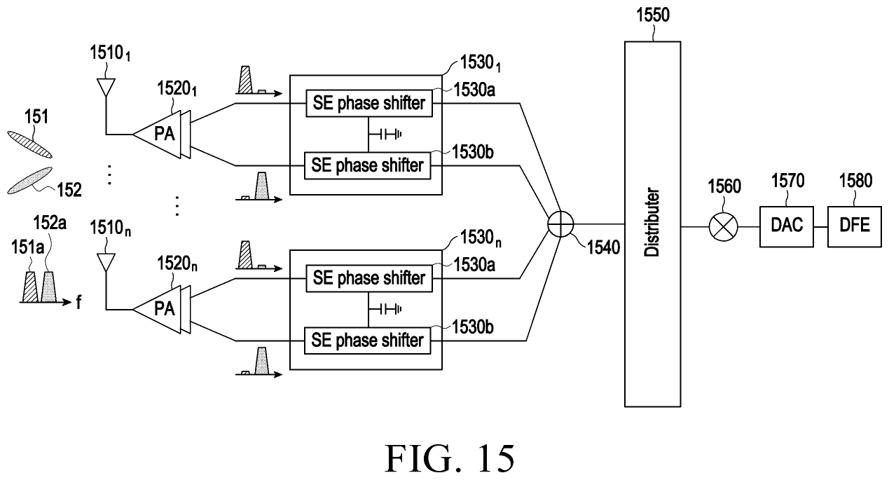

FIG. 15 is a diagram illustrating a configuration example of a transmission device of a base station that uses the pseudo differential phase shifter of FIG. 7B for multi-beamforming in a wireless communication system according to one or more embodiments.

The example of FIG. 15 illustrates a configuration in which a transmission device of a base station transmits downlink signals respectively to UEs (e.g., first UE and second UE) by using dual beams as multiple beams for ease of description. It is assumed that, in the dual beams, a first transmission beam 151 is for transmitting a downlink signal 151a of the first UE and a second transmission beam 152 is for transmitting a downlink signal 152a of the second UE. In FIG. 15, a structure of the transmission device that uses dual beams may be applied to a transmission device structure using multiple beams, which are two or more transmission beams, in the same manner.

Referring to FIG. 15, the transmission device of the base station may include an array antenna including n antenna elements 1510₁, . . . , 1510ₙ, a radio frequency integrated circuit (RFIC) or RF chip that operates in a frequency range appropriate for wireless transmission, a digital-to-analog converter (DAC) 1560 that converts a digital signal into an analog signal, and a digital front end (DFE) 1570 that is in charge of digital signal processing and performs filtering, conversion, synchronization, or the like of a received signal. The RFIC or RF chip may include a plurality of RF chains. The plurality of RF chains may include n power amplifiers (PAs) 1520₁, . . . , 1520ₙ that output differential signals with 180-degree phase differences, n pseudo differential phase shifters 1530₁, . . . , 1530ₙ, distributers 1540 and 1550, and a mixer 1560. The RFIC or RF chip may include at least one distributer and at least one mixer.

In FIG. 15, each PA of the n PAs 1520₁, . . . , 1520ₙ may amplify an RF signal transmitted via each antenna element and output an amplified RF signal, and the n pseudo differential phase shifters 1530₁, . . . , 1530ₙ may be configured in n sub-sets each of which, that is, each pseudo differential phase shifter, includes two SE phase shifters. The two SE phase shifters of each pseudo differential phase shifter (or sub-set) may have output ends connected to input ends of the corresponding PA, and may have input ends connected to input ends of the distributers 1540 and 1550. A connection structure of the distributers 1540 and 1550 is not limited to the example of FIG. 15, and may be changed to one of the various structures that use at least one distributer. When the two SE phase shifters included in each pseudo differential phase shifter (sub-set) are referred to as a first SE phase shifter 1530a and a second SE phase shifter 1530b, the first SE phase shifter 1530a may adjust a phase of an RF signal input to a corresponding PA for beamforming of the first transmission beam 151 in dual beams and may output a phase-adjusted RF signal, and the second SE phase shifter 1530b may adjust a phase of an RF signal input to the corresponding PA for beamforming of the second transmission beam 152 in the dual beams, and output a phase-shifted RF signal. The number of SE phase shifters included in each pseudo differential phase shifter (or sub-set) may be increased to correspond to the number of transmission beams in multi-beamforming. For example, when the number of transmission beams in multi-beamforming is x, the number of SE phase shifters included in each pseudo differential phase shifter (or sub-set) may be x. In the structure of FIG. 15, each antenna element and each PA may be shared by transmission beams in dual beams, and signal processing for phase adjustment for each transmission beam may be performed in each pseudo differential phase shifter (or sub-set) of the pseudo differential phase shifters 1530₁, . . . , 1530ₙ. The distributers 1540 and 1550 may distribute and output RF signals input for phase adjustment to the pseudo differential phase shifters 1530₁, . . . , 1530ₙ, and the mixer 1560 may receive a baseband signal that is output from the DFE 1580 and converted into an analog signal via the DAC 1570, and may convert the same into RF signals, and may output the RF signals.

In the transmission device of FIG. 15, each antenna element of the array antenna may be electrically connected to a single RF chain. When it is assumed that the number of antenna elements included in the array antenna is n, n antenna elements corresponding to the first antenna element 1510₁ to the n^{th} antenna element 1510ₙ may be used together for forming the first transmission beam 151 and the second transmission beam 152. The structure of FIG. 15 may differ from the structure of a transmission device of the existing base station in which each antenna element is independently used for each transmission beam. In the transmission device of FIG. 15, a first RF chain connected to the first antenna element 1510₁ may include the single PA 1520₁, the two SE phase shifters 1530₁ and 1530₂ corresponding to dual beams, the at least one distributer 1540 or 1550, and the mixer 1560. The at least one distributer 1540 or 1550 and the mixer 1560 may be shared with at least one other RF chain. In the example of FIG. 15, the downlink signal 151a of the first UE and the downlink signal 152a of the second UE, which are transmitted via the first and second transmission beams 151 and 152, may be processed in a signal path starting from the mixer 1560 and passing through the first antenna element 1510₁ to the n^{th} antenna element 1510ₙ and may be converted into an RF signal, and phase adjustment for each transmission beam may be performed in each pseudo differential phase shifter (or sub-set).

Therefore, in the transmission device structure of FIG. 15 that uses multi-beamforming, at a minimum, each antenna element and each PA may be shared between transmission beams, and only the number of phase shifters may be increased in proportion to the number of transmission beams. Accordingly, as compared with the existing transmission device structure, the number of hardware elements required in a base station may be reduced, installation costs of the base station may be reduced, and an area occupied by the hardware elements in the base station may be decreased.

Although the structure of FIG. 15 is an example of the case of using dual beams as multiple beams, the transmission device may be controlled to use a single beam by adjusting a configuration for phase adjustment by the pseudo differential phase shifters 1530₁, . . . , 1530ₙ in the structure of FIG. 15. The transmission device of FIG. 15 may include a processor that is not illustrated, and the processor may control an overall operation of the transmission device of FIG. 15 that transmits a downlink signal using a single beam or multiple beams. In the disclosure, the pseudo differential phase shifters 1530₁, . . . , 1530ₙ may be operated by one or more registers in which values for adjusting a phase of a transmission beam based on a predetermined angle are set, and values that may be set in the registers based on the number of simultaneously operated beams (e.g., 1, 2, 4, . . . or the like) may be applied/adjusted/controlled by the processor. In addition, the values that may be set in the registers based on the number of simultaneously operated beams (e.g., 1, 2, 4, . . . , or the like) may be stored in advance in a look-up table for use.

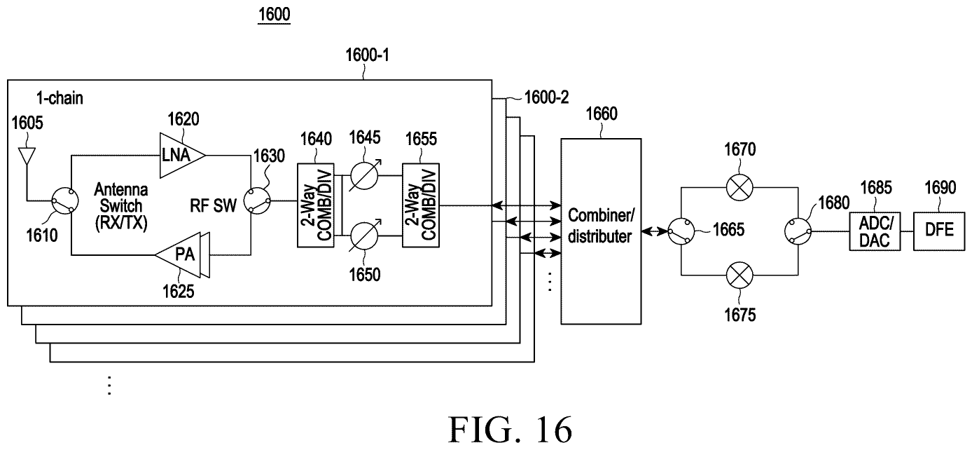

FIG. 16 is a diagram illustrating a configuration example in which a transmission device and a reception device of a base station are combined for multi-beamforming in a wireless communication system according to one or more embodiments.

Referring to FIG. 16, a base station 1600 may include a plurality of RF chains 1600-1, 1600-2, or more, a combiner/distributer 1660, switches 1665 and 1680 for switching a transmission path and a reception path, mixers 1670 and 1675 for conversion between a baseband signal and an RF signal in a transmission path and a reception path, an ADC/DAC 1685 for conversion between an analog signal and a digital signal, and a digital front end (DFE) 1690 that performs filtering, conversion, synchronization, or the like of a received signal. An RFIC or RF chip may include a plurality of RF chains 1600-1, 1600-2, or more. Each RF chain may include, for example, an antenna element 1605, switches 1610 and 1630 for switching a transmission path and a reception path, an LNA 1620/PA 1625, 2-way combiner/distributer parts 1640 and 1655 operating as a combiner in a reception path and operating as a distributer in a transmission path, and phase shifters 1645 and 1650 for phase adjustment for each transmission beam/reception beam between the 2-way combiner/distributer parts 1640 and 1655. As the phase shifters 1645 and 1650, various types of phase shifters described in the embodiments of FIGS. 4 to 15 may be used. Operation of the base station apparatus of FIG. 16 is a combination of operations of the reception device and the transmission device of the base station that have been described in the embodiments of FIGS. 4 to 15, and thus a detailed description thereof will be omitted.

In the base station structure of FIG. 16, at a minimum, each antenna element and each LNA/PA may be shared between reception/transmission beams, and only the number of phase shifters may be increased in proportion to the number of reception/transmission beams. Accordingly, as compared with the existing base station structure, the number of hardware elements required in a base station may be reduced, installation costs of the base station may be reduced, and an area occupied by the hardware elements in the base station may be decreased.

Methods disclosed in the claims and/or methods according to the embodiments described in the specification may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description, it will be apparent that various modifications and changes may be made thereto without departing from the scope. Therefore, the scope should not be defined as being limited to the embodiments set forth herein, but should be defined by the appended claims and equivalents thereof.

What is claimed is:

1. A base station comprising:
an array antenna comprising a plurality of antenna elements configured to perform beam adjustment in horizontal and vertical directions to form two or more reception beams for multi-beamforming for a plurality of user equipments (UEs); and
a plurality of radio frequency (RF) chains configured to amplify RF signals received via the plurality of antenna elements, perform phase adjustment for the multi-beamforming associated with the amplified RF signals, and output the phase-adjusted signals,
wherein each RF chain of the plurality of RF chains comprises:
a low-noise amplifier of which an input end is connected to one antenna element of the plurality of antenna elements and at least one output end is connected to two or more phase shifters, and which is configured to amplify an RF signal provided via the input end; and
the two or more phase shifters configured to perform phase adjustment for the multi-beamforming associated with the amplified RF signal received via the two or more reception beams in each RF chain for respective two or more UEs.

2. The base station of claim 1, wherein, based on the two or more reception beams comprising first to n^{th} reception beams, the two or more phase shifters in each RF chain comprise first to n^{th} phase shifters, and
wherein the first to n^{th} phase shifters in each RF chain are configured to perform the phase adjustment for the multi-beamforming associated with the first to n^{th} reception beams for respective first to n^{th} UEs.

3. The base station of claim 1, wherein the two or more phase shifters use one from among a single ended (SE) phase shifter, a differential phase shifter, and a pseudo differential phase shifter, and
wherein the pseudo differential phase shifter is configured such that two or more SE phase shifters are connected to alternating current (AC) ground.

4. The base station of claim 3, wherein, based on the pseudo differential phase shifter being used as the two or more phase shifters, the low-noise amplifier is configured to output a differential signal and the pseudo differential phase shifter is configured to receive the differential signal and output a phase-adjusted signal.

5. The base station of claim 1, wherein an RF chip comprising the plurality of RF chains further comprises at least one combiner configured to receive and combine, in the plurality of RF chains, signals that are phase-adjusted by the two or more phase shifters.

6. The base station of claim 1, further comprising a processor configured to control operation of the base station for the multi-beamforming,
wherein the processor is configured to control set values in a register of the two or more phase shifters for the multi-beamforming.

7. The base station of claim 6, wherein the processor is configured to perform communication with the plurality of UEs by dynamically applying one of the multi-beamforming and single-beamforming based on channel state information of the plurality of UEs,
wherein, in case that the multi-beamforming is applied, different register set values are applied to the two or more phase shifters, and
wherein, in case that the single-beamforming is applied, an identical register set value is applied to the two or more phase shifters.

8. A radio frequency (RF) chip for a bases station, the RF chip comprising:
a plurality of RF chains configured to amplify RF signals received via a plurality of antenna elements, perform phase adjustment for multi-beamforming associated with the amplified RF signals, and output the phase-adjusted signals,
wherein each RF chain of the plurality of RF chains comprises:
a low-noise amplifier of which an input end is connected to one antenna element of the plurality of antenna elements and at least one output end is connected to two or more phase shifters, and which is configured to amplify an RF signal provided via the input end and output an amplified RF signal; and
the two or more phase shifters configured to perform phase adjustment for the multi-beamforming associated with the amplified RF signal received via two or more reception beams in each RF chain for respective two or more user equipments (UEs).

9. The RF chip of claim 8, wherein, based on the two or more reception beams comprising first to n^{th} reception beams, the two or more phase shifters in each RF chain comprise first to n^{th} phase shifters, and
wherein the first to n^{th} phase shifters in each RF chain are configured to perform the phase adjustment for the multi-beamforming associated with the first to n^{th} reception beams for respective first to n^{th} UEs.

10. The RF chip of claim 8, wherein the two or more phase shifters use one from among a single ended (SE) phase shifter, a differential phase shifter, and a pseudo differential phase shifter, and
wherein the pseudo differential phase shifter is configured such that two or more SE phase shifters are connected to alternating current (AC) ground.

11. A base station comprising:
an array antenna comprising a plurality of antenna elements configured to perform beam adjustment in horizontal and vertical directions to form two or more transmission beams for multi-beamforming associated with a plurality of user equipments (UEs); and
a plurality of RF chains configured to perform phase adjustment for the multi-beamforming associated with radio frequency (RF) signals transmitted via the plurality of antenna elements, and amplify and output the phase-adjusted RF signals,
wherein each RF chain of the plurality of RF chains comprises:
a power amplifier of which an output end is connected to one antenna element of the plurality of antenna elements and at least one input end is connected to two or more phase shifters, and which is configured to amplify an RF signal provided via the at least one input end; and
the two or more phase shifters configured to perform phase adjustment for the multi-beamforming associated with RF signals transmitted via the two or more transmission beams in each RF chain for respective two or more UEs.

12. The base station of claim 11, wherein, based on the two or more transmission beams comprising first to n^{th} transmission beams, the two or more phase shifters in each RF chain comprise first to n^{th} phase shifters, and
wherein the first to n^{th} phase shifters in each RF chain are configured to perform the phase adjustment for the multi-beamforming associated with the first to n^{th} transmission beams for respective first to n^{th} UEs.

13. The base station of claim 11, wherein the two or more phase shifters use one from among a single ended (SE) phase shifter, a differential phase shifter, and a pseudo differential phase shifter, and
wherein the pseudo differential phase shifter is configured such that two or more SE phase shifters are connected to alternating current (AC) ground.

14. The base station of claim 13, wherein based on the pseudo differential phase shifter being used as the two or more phase shifters, the pseudo differential phase shifter is configured to receive a differential signal and output a phase-adjusted signal.

15. The base station of claim 11, wherein an RF chip including the plurality of RF chains further comprises at least one distributer configured to distribute and output, in the plurality of RF chains, signals that are phase-adjusted by the two or more phase shifters.

16. The base station of claim 11, further comprising a processor configured to control operation of the base station for the multi-beamforming,
wherein the processor is configured to control set values in a register of the two or more phase shifters for the multi-beamforming.

17. The base station of claim 16, wherein the processor is configured to communicate with the plurality of UEs by dynamically applying one of the multi-beamforming and single-beamforming based on channel state information associated with the plurality of UEs,
wherein, in case that the multi-beamforming is applied, different register set values are applied to the two or more phase shifters, and
wherein, in case that the single-beamforming is applied, an identical register set value is applied to the two or more phase shifters.

18. A radio frequency (RF) chip for a base station, the RF chip comprising:
a plurality of RF chains configured to perform phase adjustment for multi-beamforming associated with RF signals transmitted via a plurality of antenna elements, and amplify and output the phase-adjusted RF signals,
wherein each RF chain of the plurality of RF chains comprises:
a power amplifier of which an output end is connected to one antenna element of the plurality of antenna elements and at least one input end is connected to two or more phase shifters, and which is configured to amplify an RF signal provided via the at least one input end; and
the two or more phase shifters configured to perform phase adjustment for the multi-beamforming associated with RF signals transmitted via two or more transmission beams in each RF chain for respective two or more user equipments (UEs).

19. The RF chip of claim 18, wherein, based on the two or more transmission beams comprising first to n^{th} transmission beams, the two or more phase shifters in each RF chain comprise first to n^{th} phase shifters, and
wherein the first to n^{th} phase shifters in each RF chain are configured to perform the phase adjustment for the multi-beamforming associated with the first to n^{th} transmission beams for respective first to n^{th} UEs.

20. The RF chip of claim 18, wherein the two or more phase shifters use one from among a single ended (SE) phase shifter, a differential phase shifter, and a pseudo differential phase shifter, and
wherein the pseudo differential phase shifter is configured such that two or more SE phase shifters are connected to alternating current (AC) ground.
